(19) United States
(12) Patent Application Publication
(10) Pub. No.: US 2025/0178871 A1
(43) Pub. Date: Jun. 5, 2025

(54) SYSTEM AND METHOD FOR A BOOM CRANE WITH AN EXTENSIBLE POWER SOURCE ANCHORED ONLY TO THE FIRST SECTION

(71) Applicant: Custom Truck One Source, Inc., Kansas City, MO (US)

(72) Inventors: Collin Green, Kansas City, MO (US); Kyle Gerber, Kansas City, MO (US)

(73) Assignee: Custom Truck One Source, Inc., Kansas City, MO (US)

(21) Appl. No.: 19/042,537

(22) Filed: Jan. 31, 2025

Related U.S. Application Data
(63) Continuation-in-part of application No. 18/057,279, filed on Nov. 21, 2022, now Pat. No. 12,240,739.
(60) Provisional application No. 63/268,756, filed on Mar. 2, 2022.

(51) Int. Cl. B66C 23/70; B66C 13/18

(52) U.S. Cl. CPC B66C 23/703; B66C 13/18

(57) ABSTRACT

A system for design of a synchronous rope extended telescoping boom, the system including a base section, a rope extended tip section, and at least one rope extended boom section disposed between the base section and the tip section, each section having an open interior space. An extensible power source disposed within the open interior space of the base section for translating the rope extended boom sections, the power source comprising an extensible first end and an unanchored body portion, wherein the extensible first end is anchored to the base section proximate a trailing edge of the first section.

### RELATED APPLICATIONS

This application is a continuation-in-part application of U.S. application Ser. No. 18/057,279 filed on Nov. 21, 2022, which claims priority from U.S. Provisional Application No. 63/268,756 filed Mar. 2, 2022. The content of those applications is incorporated herein by reference in its entirety.

### FIELD OF THE DISCLOSURE

A system and method for design of an extensible boom crane where the barrel of the extend cylinder is not anchored to the second section, and rerouting of the ropes is achieved by the reeving of the necessary extend ropes via sheaves anchored to the base section and barrel of the extend cylinder only.

### BACKGROUND

Telescopic cranes are equipped with a boom (arm) outfitted with a hydraulic cylinder that allows it to change length, like a telescope. Many telescopic (extensible) cranes are mounted on a truck to transport to and from different worksites. Telescoping boom assemblies generally include a first longitudinal tube section attached to a mounting platform and a second longitudinal tube section that telescopes relative to the first longitudinal tube section. Additional longitudinal tube sections can be disposed within the second longitudinal tube section creating three or more extensible sections.

Multi-section telescopic booms traditionally utilize cables, often called wire ropes, to operate them. Wire ropes transfer the translational force of the telescoping cylinder to further sections not directly anchored to the cylinder. This configuration has served the crane industry well for many years; however, demands by customer to increase both load capacity and reach continue to challenge crane designers and fabricators.

The need for larger cables and sheaves to accommodate larger loads and increased reach require larger boom cross sections that provide greater space to install the larger cables and sheaves. At the same time, larger boom cross sections and wall thicknesses increase the overall weight of the boom which in turn require larger cables and sheaves that can accommodate the larger loads the sections can support.

The ever-increasing demand for hydraulically operated telescoping cranes with increased load lifting capacity and the resulting increases in size of the telescoping booms has created a need for a less massive mechanism for extending the telescoping boom. The weak link in this race for more crane lifting capacity is a commensurate need for increased wire rope capacity. Alternatively, an approach must be developed to increase the load lifting capacity of the crane but not the tensile load experienced by the wire ropes.

An additional challenge that exists with extensible boom cranes is that very long cylinders are extremely difficult to manufacture and therefore there are few vendors that can supply such cylinders. Very long cylinders are heavy, expensive, difficult to transport, hard to keep tolerances along the length post machining, and complicate the process of installation within the boom sections of the crane. Consequently, developing a system and method for fabricating a crane with a cylinder of a greatly reduced length and yet has a much greater load capacity is highly desirable.

### SUMMARY OF THE INVENTION

Disclosed herein is a system and method for designing an extensible boom crane where the extensible power source is no longer anchored to the second section, and the rerouting of the ropes is achieved by the reeving of the necessary extend ropes via sheaves anchored to the base section and a barrel (or other member) of an extensible power source. The second section is no longer extended by the extensible power source requiring another set of ropes to be added for the second section to become a rope extended section.

Throughout this disclosure the phrase extensible power source is utilized and in most industrial applications a hydraulic cylinder (barrel) with an extending piston will serve as the extensible power source. Other modes of extension such as electrical or pneumatic power sources in lieu of a hydraulic cylinder are also contemplated by this disclosure and are fully functional in the system and method disclosed herein.

In the previously disclosed application at U.S. application Ser. No. 18/057,279, the extension of the cylinder when anchored to the second section utilized a 1:1 ratio. One unit of extension of the cylinder resulted in one unit of extension of the second section. In this disclosed system and method the cylinder is not anchored to the second section and the stroke length is reduced. For illustration purposes throughout the ratio of one unit of stroke of the extension cylinder yields two units of extension of the second section.

It is an object of the disclosed system and method to utilize a hydraulic cylinder with a shorter stroke with a higher load capacity decoupled from the second section of the boom. A shorter stroke hydraulic cylinder with a higher load capacity can safely handle heavier loads. This is particularly important in situations where the crane needs to lift or move very heavy objects. A higher load capacity ensures the crane can handle these loads without the risk of failure or overstressing the hydraulic system.

It is a further object of the disclosed system and method to reduce the longitudinal aspect of the hydraulic cylinder, which means the shorter cylinder can fit into spaces where longer cylinders might be impractical. This is advantageous for maintaining the crane's overall size, maneuverability, and reach. The compact design can also reduce the overall weight of the crane, leading to improved stability and performance.

It is a further object of the disclosed system and method to facilitate faster stroke movement as shorter stroke cylinders can move the boom more quickly because they have less distance to travel, which can increase operational speed. This can improve efficiency in tasks where quick movements are important, reducing the time required to complete certain maneuvers.

It is a further object of the disclosed system and method to employ a shorter stroke hydraulic cylinder disconnected directly from the second section boom with a greater load capacity thereby allowing the boom of the crane to be built with a more robust, structurally stable design. A more powerful cylinder can generate higher forces with less extension, which can reduce wear and tear on the components of the crane over time.

It is a further object of the disclosed system and method to employ a higher load capacity hydraulic cylinder with a shorter stroke that is disconnected directly from the second section boom as that hydraulic system may require less fluid to operate resulting in reduced hydraulic power requirements thereby leading to improved fuel efficiency or a smaller, more efficient hydraulic system.

It is a further object of the disclosed system and method to employ a shorter stroke hydraulic cylinder disconnected directly from the second section boom because with a higher load capacity and shorter stroke, the crane may offer more controlled lifting actions, particularly in situations where fine-tuned movements are necessary. The greater load capacity allows for more precise handling of heavy loads, with less risk of unwanted boom movement or instability.

It is a further object of the disclosed system and method to employ a hydraulic cylinder with a shorter stroke with an increased load capacity that is disconnected directly from the second section boom because a higher load capacity means the cylinder can handle unexpected or peak loads more safely without risk of failure. Additionally, the compact design may help the crane maintain a more stable center of gravity, reducing the chances of tipping over during operation.

Various objects, features, aspects, and advantages of the disclosed subject matter will become more apparent from the following detailed description of preferred embodiments, along with the accompanying drawings in which like numerals represent like components. The contents of this summary section are provided only as a simplified introduction to the disclosure and are not intended to be used to limit the scope of the appended claims.

The contents of this summary section are provided only as a simplified introduction to the disclosure and are not intended to be used to limit the scope of the appended claims.

### BRIEF DESCRIPTION OF THE DRAWINGS

FIG. 1 illustrates an exemplary range diagram detailing articulation angle versus the load capacity on boom length;

FIG. 2 illustrates a sectional view of a prior art four-section telescoping boom detailing the location of ropes and sheaves;

FIG. 3 illustrates a sectional view of a prior art four-section telescoping boom with force magnitudes identified on the ropes, sheaves and extension cylinder;

FIG. 4 illustrates a sectional view of an embodiment of a four-section crane boom employing a hydraulic cylinder disconnected from direct extension of the second boom section;

FIG. 5 illustrates a perspective view of an embodiment of an extensible power source with reeved sheaves and ropes;

FIG. 6 illustrates a perspective view of an embodiment of a configuration of the reeved ropes of FIG. 5 with the sheaves removed;

FIG. 7 illustrates a sectional view of an embodiment of a five-section crane boom employing a hydraulic cylinder disconnected from direct extension of the second boom section;

FIG. 8 illustrates a sectional view of an embodiment of a five-section crane boom employing a hydraulic cylinder disconnected from direct extension of the second boom section displaying only the rope and sheaves for the fifth-section;

FIG. 9 illustrates a sectional view of an embodiment of a five-section crane boom employing a hydraulic cylinder disconnected from direct extension of the second boom section displaying only the rope and sheaves for the fourth-section

FIG. 10 illustrates a sectional view of an embodiment of a five-section crane boom employing a hydraulic cylinder disconnected from direct extension of the second boom section displaying only the rope and sheaves for the third-section;

FIG. 11 illustrates a sectional view of an embodiment of a five-section crane boom employing a hydraulic cylinder disconnected from direct extension of the second boom section displaying only the rope and sheaves for the second-section; and

FIG. 12 illustrates a method flow diagram for the disclosed system of a synchronous extensible boom crane with the extensible power source only anchored to the first section.

### DETAILED DESCRIPTION

Wire rope boom extension systems for cranes have existed for many years. Within a classic (traditional) wire rope extension system, a series of ropes, that run over sheaves, (a pulley over which a cable wraps around) are positioned throughout the boom. These cables drive each boom section to move synchronously when a single translation apparatus, such as a hydraulic cylinder, is extended. In a typical four section wire rope boom, the rod of the extend cylinder is anchored to the base section of the boom and the barrel is anchored to the back of the second section.

When the term rope is used in this disclosure it is contemplated that the term includes cables, synthetic rope, chain, engineered assemblies, or any other flexible components capable of transmitting large forces in tension. When the term “anchor”, “anchored,” or “anchoring” for an end of a rope is used herein it is a commonly understood term in the art and various well-known types of hardware and installation techniques are utilized to accomplish the anchoring of the ropes.

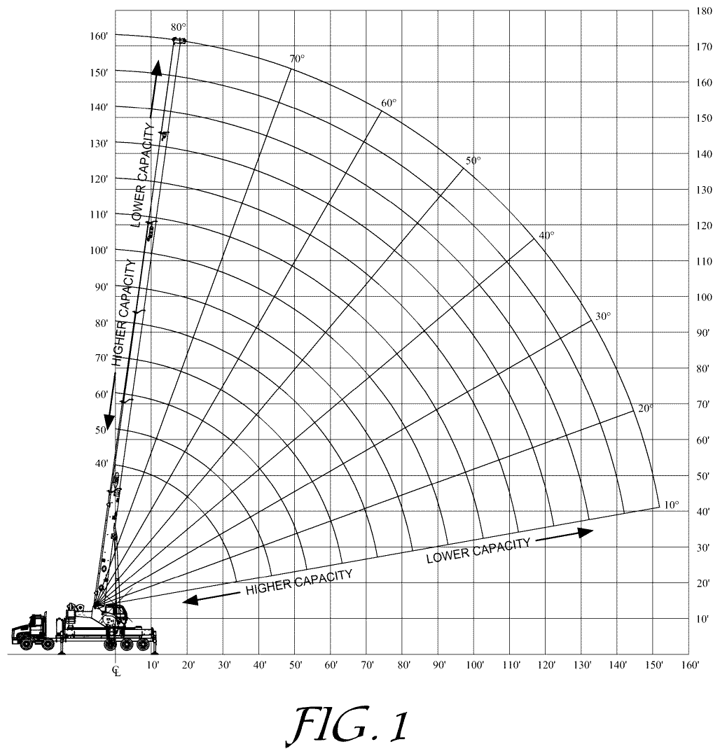

While cranes are extremely versatile, they have limitations that must be carefully observed, or serious mishaps can result. FIG. 1 reveals a range diagram for a typical extensible boom crane. The chart reveals the limitations that exist on the extension of the boom and the load that can be carried by the boom based on the ability of the crane to carry the desired load without overloading the boom sections which include the ropes, sheaves and typically the hydraulic cylinder that provides the motive force. Additionally, the range diagram establishes limits that prevent tipping of the crane because of overextension of the boom. The information disclosed herein is directed to addressing a system for increasing the load capacity of the boom by reducing the tension carried by the ropes internal to the extension system to keep the boom extended.

It should be appreciated by the reader that in operational embodiments of the system disclosed herein, the wire rope and sheave configurations will be mirrored within each boom section. More precisely, to maximize the load carrying capacity of the wire rope and to capitalize upon the increased bending flexibility of lesser diameter wire rope, two identical wire rope and sheave systems are utilized in production embodiments. These identical wire rope and sheave systems are disposed opposite one another (on each side internal to the boom) in the extensible boom sections.

A single large wire rope with the same load carrying capacity as two smaller diameter ropes has a reduced capacity to flex around the redirection sheaves and hence two smaller, more flexible, wire ropes are preferable in a fully operational context. To facilitate full and clear disclosure of the system, the placement of only one side of the sheave and wire rope system will be discussed herein; however, as noted immediately above, it is contemplated that in a production setting the boom sections will each house two identical rope and sheave systems.

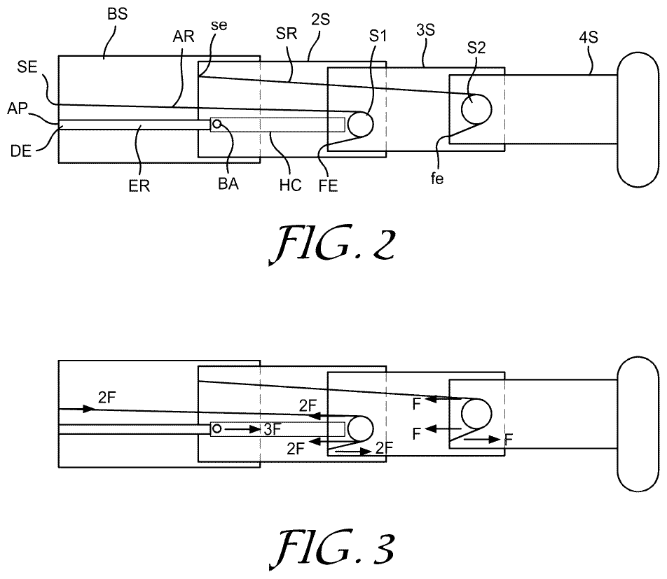

FIG. 2 illustrates a longitudinal cross-sectional view, detailing the internal ropes and sheaves, of a prior art embodiment of a four-section telescopic boom system. The first boom system embodiment includes a base section, two intermediate sections and a tip section. The boom sections are traditionally fabricated in a wide range of cross-sectional shapes to include, among others, square, rectangular, and circular. Typically, the boom sections are fabricated from high strength steel and may span from six inches to many feet in cross-section and may span in length from a few feet to over thirty feet. The wall thickness of the boom sections must necessarily vary to accommodate the overall size and intended load carrying capacity of the boom system.

The prior art design illustrated in FIG. 2 includes a hydraulic cylinder HC, also known as the barrel, with an extensible rod ER. The distal end DE of the extensible rod ER is secured to an anchor point AP on or near the first end of the base section BS of the boom system. A proximal end of the hydraulic cylinder HC is securely pinned to the second intermediate section 2S of the boom system at a barrel anchor BA proximate the first end of the second section. As the extensible rod is extended outwardly from the cylinder HC under pressure from the hydraulic fluid, it longitudinally translates the second intermediate section 2S outwardly from the base section BS.

While the hydraulic cylinder HC and extensible rod ER for the application of translational force are utilized to separate the second section 2S from the base section BS, there are other operational elements within the boom sections that cause the other two boom sections 3S, 4S to undergo translation. FIG. 2 also illustrates the location of various sheaves that are facilitating extension of the boom sections. As previously discussed, the barrel anchor BA is located proximate the first end of the second intermediate section 2S. A first sheave S1 is secured to the distal end of the hydraulic cylinder HC and a second sheave S2 is secured proximate the second end of the third section 3S.

This prior art design as illustrated at FIG. 2 also utilizes ropes under tension to convey translational force to the various boom sections of the system to cause their movement. The prior art system of FIG. 2 utilizes an anchor rope AR with first and second ends FE, SE. The anchor rope AR extends over, and partially circumscribes the first sheave S1 with the first end FE anchored proximate the first end of the third section 3S. The second end SE of the anchor rope AR is anchored at the base section BS at an anchor point.

The second, smaller diameter rope SR, as also illustrated at FIG. 2, includes first and second ends fe, se with the first end fe anchored proximate to the first end of the fourth section 4S of the system. The smaller diameter rope SR passes around the second sheave S2 that is secured proximate to the second end of the third section 3S. Finally, the second end (se) of the second smaller rope SR is anchored proximate to the first end of the second section 2S of the system.

As noted above, the first and second ropes AR, SR in this prior art configuration are of different thicknesses because the tension carried in the larger anchor rope AR is greater than the tension carried in the second smaller rope SR. When larger ropes are required to carry the specified maximum load then the sheaves over which the load carrying ropes run must also have a greater diameter and thickness. Increasing the dimensions of the sheaves and ropes results in a more densely crowded interior of the boom assembly. A more tightly packed set of boom sections is more challenging for initial fabrication as well as to access for repair and replacement of components internal to the telescoping boom assembly and therefore it is highly desirable to reduce the size of ropes, as well as the width and diameter of sheaves, yet maintain a high load carrying capacity. Larger diameter sheaves are required for larger ropes with greater load carrying capacity because larger ropes simply cannot curve around smaller diameter sheaves as readily as smaller ropes. Larger diameter ropes in turn require larger spacing between cross sections.

Table 1 and FIG. 3 provide a summary of the forces acting on each element of the previously described prior art telescoping boom assembly. The load for each sheave identifies the load at the anchor point for that specific sheave. As can be seen in Table 1 and FIG. 3, the load on Rope 2 is equivalent to the load applied at the tip (F). The load on Rope 1 is twice the load applied to the tip section. The load on Rope 1 is of particular concern because that rope must have a greater capacity to resist the operating load applied to the tip section of the boom. As previously mentioned, larger ropes require larger sheaves and consume more space in the already limited interior of the boom sections thereby complicating boom section fabrication as well as maintenance and repair operations.

TABLE 1
LOAD FACTORS BY COMPONENT

| | | Load |
|---|---|---|
| No. | Element | Factor |
| | Operating load applied to the tip section | F |
| 1 | Sheave 1 (left) S1 | 4F |
| 2 | Sheave 2 (right) S2 | 2F |
| 3 | Rope 1 AR | 2F |
| 4 | Rope 2 SR | F |
| 7 | Force required to extend the rod from the | 3F |
| | cylinder | |

The disclosed system and method are directed to embodiments where the barrel of the extend cylinder is no longer anchored to the second section, and the rerouting of the ropes is achieved by the reeving of the necessary extend ropes via sheaves anchored to the base section and barrel of the extend cylinder only. Importantly, the second section is no longer extended by the telescoping cylinder. Consequently, another set of ropes must be added for the second section to become a rope extended section.

In U.S. application Ser. No. 18/057,279, the extension of the cylinder when attached to the second section has a 1:1 ratio. One unit of extension of the cylinder results in one unit of extension of the second section as the barrel of the hydraulic cylinder is anchored (pinned) to the second section and the tip of the extending piston is anchored proximate to the trailing edge of the first section. The system and method disclosed herein now provide that neither the piston nor the barrel are anchored to the second section and the available stroke is reduced, such as by half or possibly even to a third. One unit of stroke of the barrel now needs, for example, to equal two units of extension of the second section. The significance of the system and method as disclosed herein is that a cylinder of, for example, half the length of the cylinder utilized in the previously disclosed U.S. patent application Ser. No. 18/057,279 carries a load that is doubled the original cylinder.

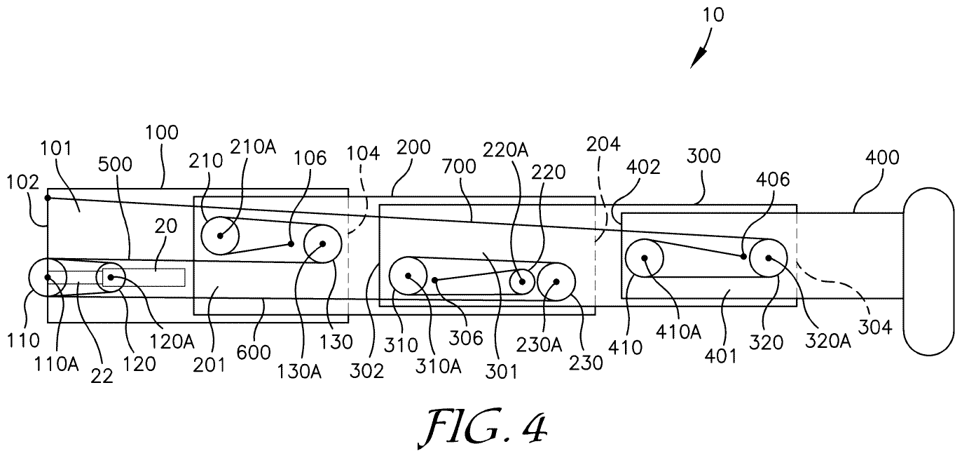

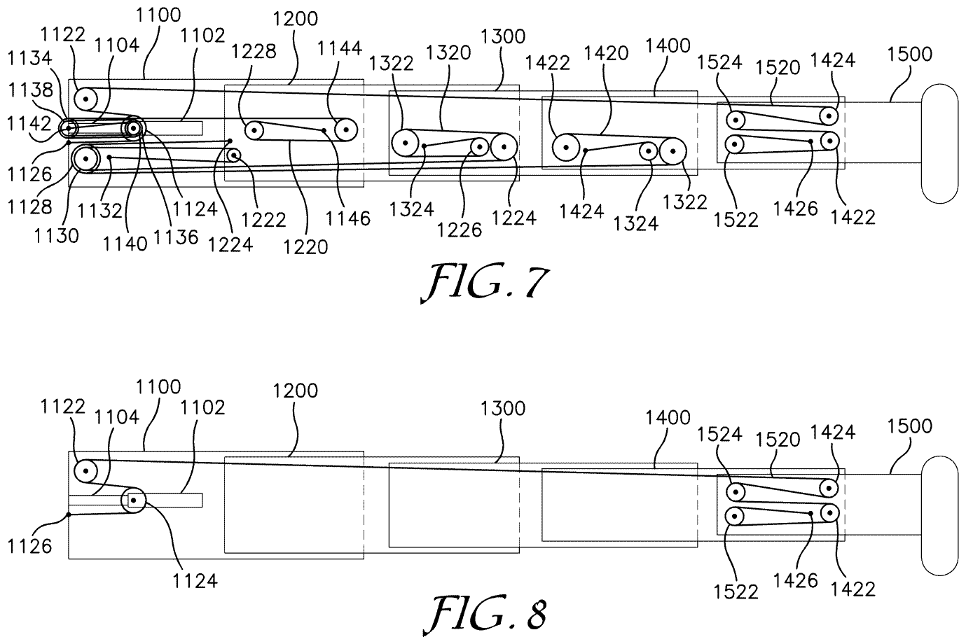

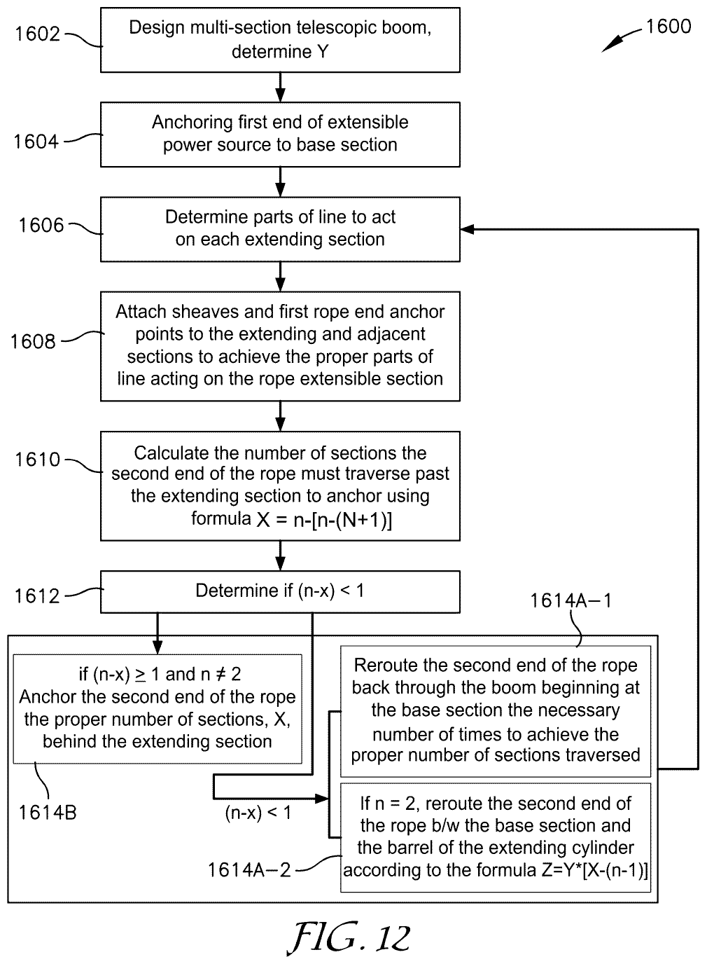

To achieve synchronous extension under the disclosed system and method where the barrel of the extend cylinder is no longer anchored to the second section, FIG. 12 identifies the steps of the method 1600 a designer may follow. FIG. 12 has been used to show the process in determining proper rope routing for FIG. 4; however, the designer has achieved synchronous extension in the embodiment of FIG. 7 by following similar steps without following the steps of the method 1600 set forth at FIG. 12.

The first step 1602 of the disclosed method 1600 is designing a multi-section telescopic boom and determining the value of the variable Y, which is the stroke ratio of the second section extension relative to the extension of the extensible power source (e.g., a hydraulic cylinder). The second step 1604 is the anchoring of the first end of an extensible power source to the base section of the boom. The third step 1606 through the seventh step 1614 is an iterative loop to be accomplished for each extending boom section.

The third step 1606 requires the designer to determine the parts of line to act on each rope extended section. The fourth step 1608 requires the attachment of sheaves and the first rope end anchor points to the extending and adjacent sections to achieve the proper parts of line acting on each rope extended section. The fifth step 1610 requires the calculation for each rope extended section of the boom the number of sections the second end of the rope must traverse past the extending section to anchor for synchronous extension using the formula X=n−[n−(N+1)]. Where n is the extending section number, N is the number of parts of line acting on the extending section, and X is the number of sections the second end of the rope must traverse to achieve synchronous extension.

The sixth step 1612 requires the calculation of n−X and if the value n−X is less than one [(n−X)<1] then move on to step 1614A. If n−X is not less than one then move on to step seven 1614B. The seventh step 1614A has two options, option one at 1614A-1 or option two at 1614A-2 that may be chosen with the caveat if the extending section is the second section, then option two at 1614A-2 must be chosen. Option one 1614A-1 is to reroute the second end of the rope back through the boom beginning at the base section the necessary number of times to achieve the proper number of sections traversed. Step seven 1614A could also be option two, 1614A-2, which requires the rerouting of the second end of the rope between the base section and the barrel of the extending cylinder a calculated number of times according to equation Z=Y*[X−(n−1)]. The value of the variable Y is determined by calculating the ratio of the second section extension to the extension of the extensible power source. The variable Z represents the number of times the rope must be rerouted between the base section and the cylinder barrel.

Step seven 1614B requires the anchoring of the second end of the rope the proper number of sections, as per the calculated value of the variable X, behind the extending section. To comprehend the new boom extension system disclosed herein, one must appreciate the mechanical advantage provided by a block and tackle system. The system 10 as disclosed herein provides considerable mechanical advantage as compared to traditional telescoping boom systems.

### EXAMPLE 1

The embodiment in FIG. 4 illustrates a four-section boom model extended synchronously by the disclosed system and method. The sections are the base 100, second section 200, third section 300, and tip or fourth section 400. This embodiment is analyzed by boom section to explain the design process in calculating the sections traveled for synchronous extension of a boom using multiple parts of line to extend each rope extended section. Section one does not utilize a rope, however, section two 200 utilizes rope 500, section three 300 utilizes rope 600, and section 400 utilizes rope 700. The first step 1602 of the method 1600 (as illustrated at FIG. 12) for this Example 1, is accomplished by determining that a four-section telescopic boom shall be designed, and in this instance the designer has chosen a ratio of 2:1; for every two feet of extension of the second section 200 the cylinder barrel 20 must extend one foot with a stroke ratio Y of 2:1, or Y=2. The second step 1604 is accomplished by the designer anchoring the rod of the extensible power source 22 to the base section 100 of the boom.

The third step 1606 starts the iterative process and begins at the tip section. The designer starts with the tip section 400 of the boom and determines how many parts of line to use for extending the tip section 400. In this embodiment, the designer has chosen two parts of line to extend the tip section. The fourth step 1608 is accomplished by sheave 410 anchored in section four 400 and the sheave 320 anchored in section three 300 along with an anchor point 406 located in section 300. Counting the number of lines acting on the sheaves and anchor points attached to the fourth section 400 reveals the parts of line to equal two.

This provides the data required for the equations in step five 1610, where n=4 and N=2. Consequently, the number of sections the tip section 400 extend rope 700 must traverse to achieve synchronous extension is calculated as shown in step five 1610.

$$X = 4 - [ 4 - ( 2 + 1 ) ] = 3 sections$$

Step six 1612 is to calculate n−X.

4−3=1, which is not less than 1.

Therefore, the designer goes to option seven 1614B as illustrated at FIG. 12. For the tip extend rope 700 second end to traverse three sections it traverses through section three 300, section two 200, and through to section one 100. Therefore, Z does not need to be calculated and rope 700 has traversed three sections achieving synchronous extension with the boom sections.

The designer then moves on to the third section 300 of the boom, as illustrated at FIG. 4, and begins again at step three 1606. The designer determines how many parts of line to use for extending the third section 300. In this embodiment, the designer has chosen three parts of line to extend the third section 300. The fourth step 1608 is accomplished by sheave 310 and point 306 anchored in section three 300 and the sheaves 220 and 230 anchored in section two 200. Counting the number of lines acting on the sheaves and anchor points attached to the third section 300 reveals three parts of line.

This provides the data required for the equations in step five 1610, where n=3 and N=3. Consequently, the number of sections the third section 300 extend rope 600 must traverse to achieve synchronous extension is calculated as previously detailed with the equation set forth in FIG. 12.

$$X = 3 - [ 3 - ( 3 + 1 ) ] = 4 sections$$

Step six 1612 is to calculate n−X.

3−4=minus 1, which is less than 1.

Therefore, the designer chooses to go to option seven 1614A. The designer chooses option 1614A-2. Z must then be calculated

$$Z = 2 * [ 4 - ( 3 - 1 ) ] = 4$$

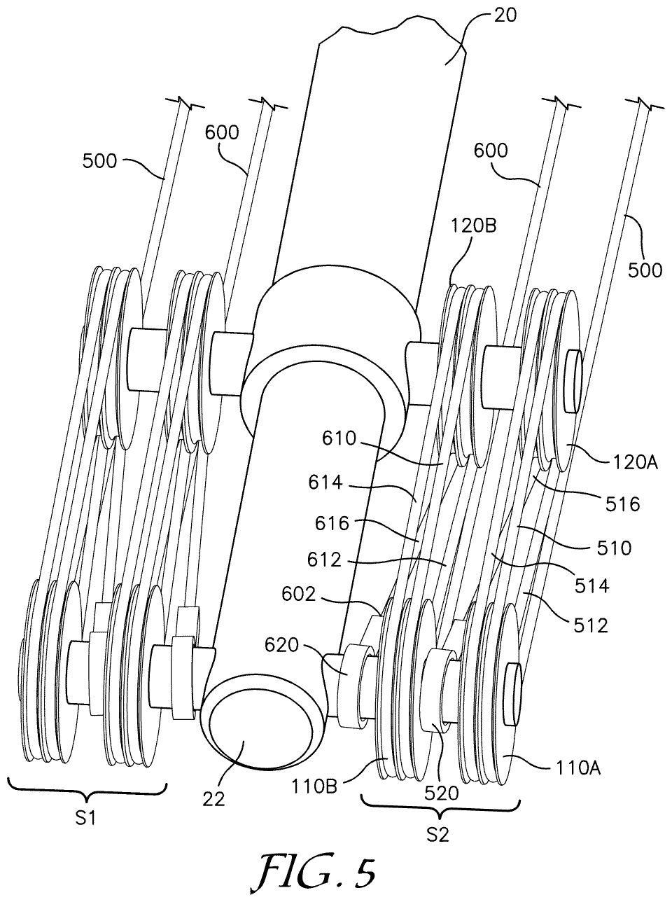

For rope 600 to traverse four sections it traverses through section two 200, and through to section one 100. However, this is only two sections traversed. Thus, rerouting rope 600 between the base section 100 and the extend barrel cylinder the calculated Z=4 number of times shall achieve synchronous extension with the rest of the boom. According to FIG. 5 this is achieved by reroute one 610 off of sheave 110B, reroute two 612 off of sheave 120B, reroute three 614 off of sheave 110B, and reroute four 616 off of sheave 120B and then anchoring rope 600 at anchor point 620.

The designer lastly moves to the second section 200 of the boom, as illustrated at FIG. 4, and begins again at step three 1606. The designer determines how many parts of line to use for extending the second section 200. In this embodiment, the designer has chosen two parts of line to extend the second section 200. The fourth step 1608 is accomplished by sheave 210 anchored in section two 200 and the sheave 130 and anchor point 106 anchored in section one 100. Counting the number of lines acting on the sheaves and anchor points attached to the second section 200 reveals the parts of line to equal to two.

This provides the data required for the equations in step five 1610, where n=2 and N=2. Consequently, the number of sections the second section 200 extend rope 500 must traverse to achieve synchronous extension is calculated as previously detailed with the equation set forth in FIG. 12.

$$X = 2 - [ 2 - ( 2 + 1 ) ] = 3 sections$$

Step six 1612 is to calculate n−X.

2−3=minus 1, which is less than 1.

Therefore, the designer must move to option seven A 1614A-2 since this is the second section. Z must then be calculated

$$Z = 2 * [ 3 - ( 2 - 1 ) ] = 4$$

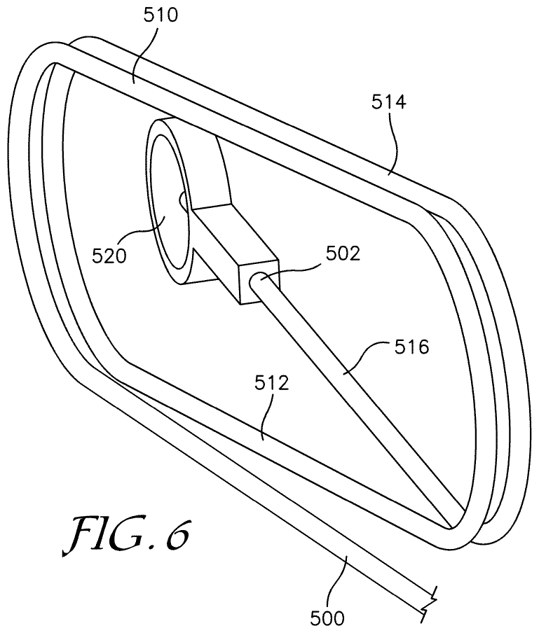

For rope 500 to traverse four sections it traverses to section one 100; however, this is only one section traversed. Thus, rerouting rope 500 between the base section 100 and the extend barrel cylinder the calculated Z=4 number of times shall achieve synchronous extension with the rest of the boom. According to FIGS. 5 and 6 by reroute one 510 off of sheave 110A, reroute two 512 off of sheave 120A, reroute three 514 off of sheave 110A, and reroute 4 516 off of sheave 120A and rope 500 is anchored at anchor point 520.

The boom illustrated at FIG. 4 achieves synchronous extension with the barrel of the extend cylinder no longer attached to the second section and having a ratio of Y=2. The diagram at FIG. 12 outlines a method for synchronous extension of a telescoping boom and utilizes the reference numbers set forth in FIG. 4; however, the process is applicable to extensible boom cranes with a greater or lesser number of boom sections as well as booms with different sheave configurations that are dependent upon a designers choice of rope tensions and the length and diameter of the extensible power source.

### EXAMPLE 2

The embodiment illustrated at FIG. 7 reveals a five-section boom model extended synchronously by the disclosed system and method. The sections are the base 1100, second section 1200, third section 1300, fourth section 1400, and tip or fifth section 1500. This embodiment is simplified into four other figures to explain the design process in calculating the sections traveled for synchronous extension of a boom using multiple parts of line to extend each rope extended section. Section one does not utilize a rope, however, section two 1200 utilizes rope 1220, section three 1300 utilizes rope 1320, section 1400 utilizes rope 1420, and section 1500 utilizes rope 1520.

First, the designer selects the stroke ratio of the second section 1200 extension to the cylinder barrel 1102 extension. In this instance the designer has chosen a ratio of 2:1; for every 2 feet of extension of the second section 1200 the cylinder barrel 1102 must extend 1 foot. A piston 1104 that extends outward from the barrel 1102 is anchored (preferably near the tip of the piston) proximate the trailing edge 1106 of the first section 1100. For the equation calculating Z, or the number of times a rope must be rerouted between the base section 1100 and the barrel of the extend cylinder 1102, Y=2.

As best illustrated at FIG. 8, the designer starts with the tip section 1500 of the boom and determines how many parts of line for extending the tip section 1500. In this embodiment, the designer has chosen four parts of line to extend the tip section. The parts of lines are determined by a review of the sheaves 1522, 1524 anchored in section five 1500 and the sheaves 1422, 1424 anchored in section four 1400 along with an anchor point 1426 located in section four 1400. Counting of the lines acting on the sheaves or anchor points attached to section five 1500 reveals the parts of line equals four (4). This provides the data required for the equations, where n=5 and N=4. Consequently, the number of sections the tip section 1500 extend rope 1520 second end must traverse to achieve synchronous extension is calculated as previously detailed with the equation set forth in Example 1 above.

$$X = 5 - [ 5 - ( 4 + 1 ) ] = 5 sections$$

For rope 1520 to traverse five sections it traverses through section four 1400, section three 1300, section two 1200, and through to section one 1100. However, this is only four sections traversed. Therefore, the designer may choose to reroute the rope 1520 back up through the boom to section two 1200, or the designer has the option to calculate the variable Z and reroute the rope 1520 between the base section 1100 and the barrel of the extend cylinder 1102 the calculated number of times. The designer in this embodiment has elected to reroute the rope 1520 between the base section 1100 and the barrel of the extend cylinder 1102. The designer calculates the value of Z as follows:

$$Z = 5 * [ 5 - ( 5 - 1 ) ] = 2$$

This means that the rope 1520 needs to be rerouted twice. The first is from sheave 1122 anchored to the base section 1100 to sheave 1124 anchored to the barrel of the extend cylinder 1102. The second is from sheave 1124 anchored to the barrel of the extend cylinder 1102 to the anchor point 1126 anchored to the base section 1100. The tip section 1500 will now achieve synchronous extension with all the other sections of the boom.

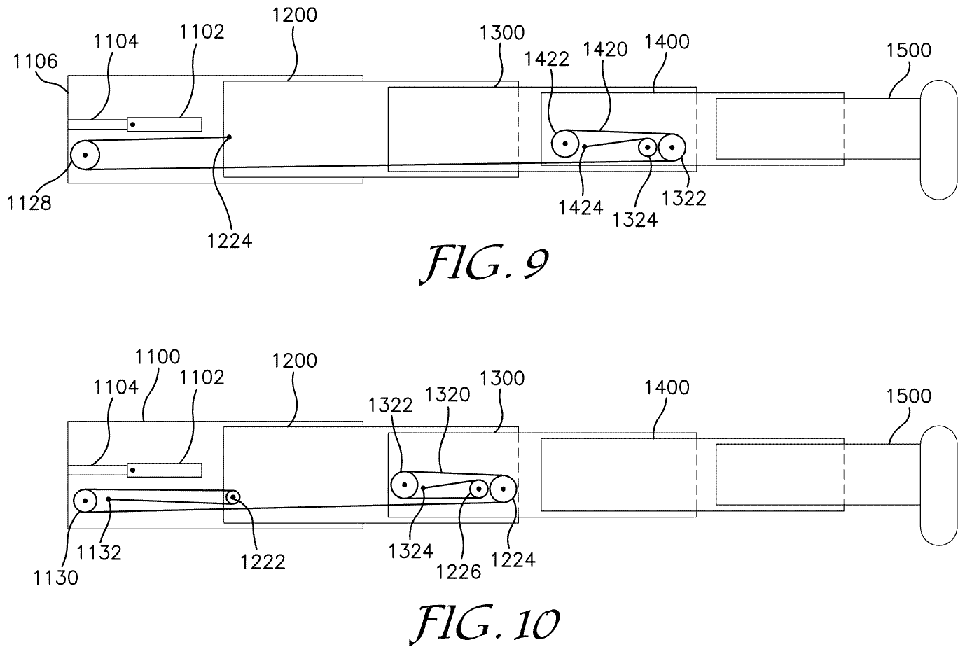

The designer then moves on to the fourth section 1400 of the boom, as illustrated at FIG. 9, and determines how many parts of line are required to extend the fourth section 1400. The designer has chosen three parts of line to extend the fourth section. The three parts of line is established with the placement of sheave 1422 anchored in section four 1400 and the placement of sheaves 1322 and 1324 anchored in the third section 1300. Extend rope 1420 is routed around sheave 1322, then 1422 and finally 1324 before being anchored at anchor point 1424 inside of section 1400. Counting of the lines acting on the sheaves or anchor points attached to section four 1400 reveals three parts of line. This provides the data necessary for the equations, where n=4 and N=3. Therefore, upon calculating the number of sections the fourth section 1400 extend rope 1420 second end must traverse to achieve synchronous extension.

$$X = 4 - [ 4 - ( 3 + 1 ) ] = 4 sections$$

For rope 1420 to traverse four sections it traverses through section three 1300, section two 1200, and through to section one 1100. However, this is only three sections traversed. Therefore, the designer may choose to reroute the rope 1420 back up through the boom to section two 1200 or the designer may alternatively elect to calculate Z and reroute the rope 1420 between the base section 1100 and the barrel of the extend cylinder 1102 the calculated number of times. The designer for this embodiment has chosen to reroute the rope 1420 from sheave 1128 anchored to section one 1100 back up to anchor point 1224 anchored at section two 1200. Therefore, Z does not need to be calculated and rope 1420 has traversed four sections achieving synchronous extension with the remaining sections of the boom.

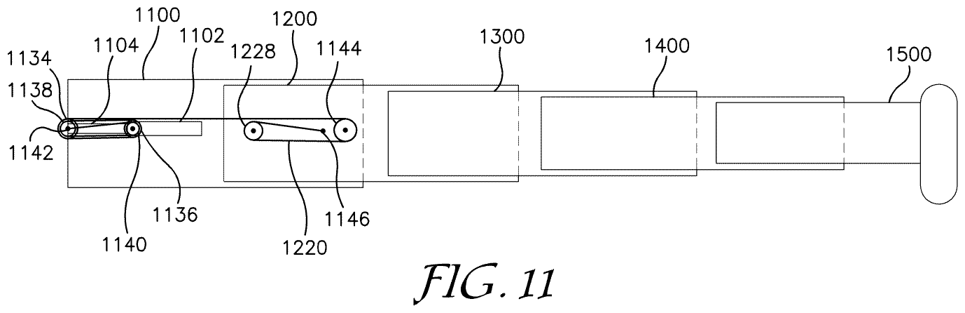

The designer then moves on to the third section 1300, as illustrated at FIG. 10 and determines how many parts of line are required to extend the third section 1300. The designer in this embodiment has chosen three parts of line to extend the third section. The three parts of line are determined by the placement of sheaves 1224 and 1226 anchored in section 1200 along with sheave 1322 anchored in section three 1300. The extend rope 1320 partially circumscribes sheaves 1224 then 1322 and is then routed to sheave 1226 before being anchored at anchor point 1324 anchored in section three. Counting of the lines acting on the sheaves or anchor points attached to the section three 1300 reveals three parts of line. This provides the data for the equations, to include the values of n=3 and N=3. Therefore, the number of sections is calculated, and the third section 1300 extend rope 1320 second end must traverse the calculated number of sections to achieve synchronous extension.

$$X = 3 - [ 3 - ( 3 + 1 ) ] = 4 sections$$

For rope 1320 to traverse four sections it traverses through section two 1200, and then through to section one 1100. However, this is only two sections traversed. Therefore, the designer may choose to reroute the rope 1320 back up through the boom or the designer may elect to calculate Z and reroute the rope 1320 between the base section 1100 and the barrel of the extend cylinder 1102 the calculated number of times. The designer for this embodiment has chosen to reroute the rope 1320 back up through the boom from sheave 1130 anchored to section one 1100 back up to sheave 1222 anchored at section two 1200. Then the rope is routed from sheave 1222 anchored to section two 1200 back to anchor point 1132 anchored at section one 1100. Therefore, Z does not need to be calculated and rope 1320 has traversed four sections achieving synchronous extension with the boom sections.

The designer finally ends with the second section 1100 of the boom as illustrated at FIG. 11 and determines how many parts of line are required to extend the second section 1200. The designer for this embodiment has chosen two parts of line to extend the second section 1200. This is confirmed by a review of FIG. 11 illustrating that extend rope 1220 partially circumscribes sheave 1144 anchored at section one 1100 then extends to sheave 1228 anchored at section two 1200 before extending to anchor point 1146 anchored at section one 1100. Counting of the lines acting on the sheaves or anchor points attached to section two 1200 reveals two parts of line. This extend rope configuration reveals two parts of line. The data for the equations are n=2 and N=2. Therefore, the number of sections the second section 1200 extend rope 1220 must traverse to achieve synchronous extension is calculated as follows.

$$X = 2 - [ 2 - ( 2 + 1 ) ] = 3 sections$$

For rope 1220 to traverse three sections it traverses to section one 1100. However, this is only one section traversed. Therefore, for the system and method disclosed herein, the section two 1200 extend rope 1220 must always be routed over the cylinder 1102. The designer must calculate Z and reroute the rope 1220 between the base section 1100 and the barrel of the extend cylinder 1102 the calculated number of times. Thus, the designer calculates Z

$$Z = 2 * [ 3 - ( 2 - 1 ) ] = 4$$

This means that the rope 1220 must be rerouted four times. The first is from sheave 1134 anchored to the base section 1100 to sheave 1136 anchored to the barrel of the extend cylinder 1102. The second is from sheave 1136 anchored to the barrel of the extend cylinder 1102 to the sheave 1138 anchored to the base section 1100. The third is from sheave 1138 anchored to the base section 1100 to sheave 1140 anchored to the barrel of the extend cylinder 1102. The fourth is from sheave 1140 anchored to the barrel of the extend cylinder 1102 to the anchor point 1142 anchored to the base section 1100. The second section 1200 will now achieve synchronous extension with the rest of the boom as it has been rerouted four times between the base section 1100 and the barrel of the extend cylinder 1102. Upon completing the above referenced calculations and routing the extend ropes consistent with the findings above, the sheave and rope configuration synchronously extends a five section boom as illustrated at FIG. 7.

The process flow chart at FIG. 12 outlines a method for synchronous extension of a telescoping boom. This process is applicable to extensible boom cranes with a greater or lesser number of boom sections than are set forth in FIG. 4, as well as booms with different sheave configurations that are dependent upon a designers choice of rope tensions and the length and diameter of the extensible power source.

The methodologies as outlined above yield a synchronous extensible boom system that is capable of increased load capacity for the same size of rope diameter and sheave width as compared to extensible boom systems that are currently employed that do not employ the disclosed system and method. Consequently, an extensible boom designer may elect to specify a larger load capacity for the extensible boom or reduce the rope diameter and cross-sectional dimension of the boom sections and maintain a similar load capacity.

The disclosed system and method should not be construed as limiting in any way. Instead, the present disclosure is directed toward all novel and nonobvious features and aspects of the various disclosed embodiments, alone and in various combinations and sub-combinations with one another. The disclosed system and method are not limited to any specific aspect or feature or combination thereof, nor do the disclosed embodiments require that any one or more specific advantages be present, or problems be solved.

In view of the many possible embodiments to which the principles of the disclosed invention may be applied, it should be recognized that the illustrated embodiments are only examples of the disclosure and should not be taken as limiting the scope of the invention. Rather, the scope of the invention is defined by the following claims. We therefore claim as our invention all that comes within the scope of these claims.

The disclosure presented herein is believed to encompass at least one distinct invention with independent utility. While the at least one invention has been disclosed in exemplary forms, the specific embodiments thereof as described and illustrated herein are not to be considered in a limiting sense, as numerous variations are possible. Equivalent changes, modifications, and variations of the variety of embodiments, materials, compositions, and methods may be made within the scope of the present disclosure, achieving substantially similar results. The subject matter of the at least one invention includes all novel and non-obvious combinations and sub-combinations of the various elements, features, functions and/or properties disclosed herein and their equivalents.

Benefits, other advantages, and solutions to problems have been described herein regarding specific embodiments. However, the benefits, advantages, solutions to problems, and any element or combination of elements that may cause any benefits, advantage, or solution to occur or become more pronounced are not to be considered as critical, required, or essential features or elements of any or all the claims of at least one invention.

Many changes and modifications within the scope of the instant disclosure may be made without departing from the spirit thereof, and the one or more inventions described herein include all such modifications. Corresponding structures, materials, acts, and equivalents of all elements in the claims are intended to include any structure, material, or acts for performing the functions in combination with other claim elements as specifically recited. The scope of the one or more inventions should be determined by the appended claims and their legal equivalents, rather than by the examples set forth herein.

Benefits, other advantages, and solutions to problems have been described herein regarding specific embodiments. Furthermore, the connecting lines, if any, shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

In the detailed description herein, references to “one embodiment,” “an embodiment,” “an example embodiment,” etc., indicate that the embodiment described may include a feature, structure, or characteristic, but every embodiment may not necessarily include the feature, structure, or characteristic. Moreover, such phrases are not necessarily referring to the same embodiment. Further, when a feature, structure, or characteristic is described relating to an embodiment, it is submitted that it is within the knowledge of one skilled in the art to affect such feature, structure, or characteristic relating to other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The methods as described in the claims are not limited to the precise sequence or specific steps outlined therein. Variations, modifications, or equivalent steps that achieve the same or substantially similar result as those specified in the claim shall also be considered within the scope of the invention, provided they do not depart from the underlying inventive concept.

The invention has been described above with reference to one or more preferred embodiments, it will be appreciated that various changes or modifications may be made without departing from the scope of the invention as defined in the appended claims.

We claim:

1. A system for design of a synchronous rope extended telescoping boom, the system comprising:
a base section, a rope extended tip section, and at least one rope extended boom section disposed between the base section and the tip section, each section further comprising an open interior space;
an extensible power source disposed within the open interior space of the base section for translating the rope extended boom sections, the power source comprising an extensible first end and an unanchored body portion, wherein the extensible first end is anchored to the base section proximate a trailing edge of the first section;
a sheave anchored proximate the trailing edge of the base section;
a sheave mounted to the unanchored body portion of the extensible power source;
at least one rope operable upon each rope extended section of the telescopic boom, the at least one rope disposed within the open interior space and comprising a first end and a second end;
the first and second ends of the at least one rope anchored within the open interior space of each rope extended section of the extensible telescopic boom;
at least one sheave anchored within the open interior space of each section to achieve an increase in a parts-of-line and thereby lower the tension in the at least one rope; wherein
to be calculated for each extending section, the variable X represents the number of sections the at least one rope must traverse to achieve synchronous extension and is determined through solution of the equation
$$X = n - [ n - ( N + 1 ) ]$$
wherein, in the formula
n represents the section number that is being extended;
N represents the number of parts of line acting on the extended section; wherein
only if the value of n−X is less than one, then calculate the value of Z which determines the number of times the rope for that extended section must be rerouted between the sheave mounted proximate the trailing edge of the base section and the sheave anchored to the body portion of the extensible power source
$$Z = Y * [ X - ( n - 1 ) ]$$
wherein,
Y is the selected stroke ratio of the second section extension distance to extensible power source extension distance, such that for each extensible section, the extend rope for that section must span between the sheave proximate the trailing edge of the base section and the sheave anchored to the body portion of the extensible power source the number of times as determined by the value of Z.

2. The system of claim 1, wherein two units of extension for the second section to one unit of stroke of the extensible power source yields a stroke ratio of two.

3. A method for synchronous extension of a telescoping boom, the method comprising:
assembling telescoping boom sections to include a base section, a tip section and at least one boom section disposed between the base section and the tip section, each telescoping boom section comprising an open interior;
anchoring a first end of an extensible power source within the open interior space of the base section proximate the trailing edge of the first section for translating the plurality of rope extended boom sections, the extensible power source comprising an unanchored body portion;
anchoring a sheave proximate the trailing edge of the base section
anchoring a sheave to the body portion of the extensible power source;
installing a plurality of ropes each with a first end and a second end within the open interior space, each rope operable to rope extend only one section; wherein,
at a first step anchoring at least one sheave within the open interior space of each section to achieve an increase in a parts-of-line and thereby lower the tension in the at least one rope; wherein
at a second step, calculating for each rope extended section of the boom a result for the formula,
$$X = n - [ n - ( N + 1 ) ]$$
wherein,
X is the number of sections the second end of the rope must traverse to achieve synchronous extension;
N is the number of parts of line acting on the extended section;
n is the number of the section being extended;
at a third step, only if the value of n−X is less than one calculating for each rope extended section of the boom the formula,
$$Z = Y * [ X - ( n - 1 ) ]$$
wherein,
Z is the number of times the extend rope must be routed between the base section and the sheave mounted to the unanchored body portion of the extensible power source;
Y is the designated stroke ratio of the second section extension to the extension of the extensible power source;
n is the number of the section being extended
to achieve synchronous extension, the extend rope for each section must be reeved between the sheave proximate the trailing edge of the base section and the sheave anchored to the body portion of the extensible power source the number of times as determined by the value of Z, and
and must be reeved between the sheave proximate the trailing edge of the base section and the sheave anchored to the body portion of the extensible power source the number of times as determined by the value of Z if n=2.
